(19) United States
(12) Patent Application Publication
(10) Pub. No.: US 2014/0184619 A1
(43) Pub. Date: Jul. 3, 2014

(54) SYSTEM-ON-CHIP PERFORMING DYNAMIC VOLTAGE AND FREQUENCY SCALING

(71) Applicant: Samsung Electronics Co., Ltd., Suwon-si (KR)

(72) Inventor: Se Ho Kim, Anyang-si (KR)

(73) Assignee: Samsung Electronics Co., Ltd., Suwon-si (KR)

(21) Appl. No.: 14/136,223

(22) Filed: Dec. 20, 2013

(30) Foreign Application Priority Data
Jan. 3, 2013 (KR) 10-2013-0000508

(51) Int. Cl. G06T 1/20

(52) U.S. Cl. CPC G06T 1/20
USPC 345/519

(57) ABSTRACT

A system-on-chip (SoC), measures the workload of a graphics processing unit (GPU), compares the frame process speed of the GPU with the frame rate of a display device, and adjusts the operating frequency of the GPU based on the comparison result and the workload of the GPU.

### CROSS-REFERENCE TO RELATED APPLICATIONS

This application claims the benefit of Korean Patent Application No. 10-2013-0000508, filed on Jan. 3, 2013, in the Korean Intellectual Property Office, the disclosure of which is incorporated herein in its entirety by reference.

### BACKGROUND

Inventive concepts relate to a system-on-chip (SoC) and a method of operating the same, and more particularly, to a SoC capable of dynamically controlling the operating frequency of a module.

A SoC may be used in portable devices and may entail a complicated system having various functions such as a processor function, a multimedia function, a graphic function, an interface function, and a security function, for example. A method and apparatus for enhancing the performance of the SoC and minimizing power consumption, particularly in portable devices would be of interest.

### SUMMARY

In exemplary embodiments in accordance with principles of inventive concepts, a method includes: (a) measuring the workload and frame process speed of a graphics processing unit (GPU) and the frame rate of a display device; (b) comparing the frame process speed of the GPU with the frame rate of the display device; and (c) adjusting an operating frequency of the GPU, based on a comparison result and the workload of the GPU.

In exemplary embodiments in accordance with principles of inventive concepts, (c) comprises maintaining the operating frequency of the GPU when the workload of the GPU is greater than an up-threshold and the frame process speed of the GPU is equal to or greater than the frame rate of the display device.

In exemplary embodiments in accordance with principles of inventive concepts, (c) comprises increasing the operating frequency of the GPU when the workload of the GPU is greater than an up-threshold and the frame process speed of the GPU is less than the frame rate of the display device.

In exemplary embodiments in accordance with principles of inventive concepts, (c) further comprises reducing the operating frequency of the GPU when the workload of the GPU is less than or equal to the up-threshold and is less than a down-threshold.

In exemplary embodiments in accordance with principles of inventive concepts, the up-threshold and the down-threshold are values corresponding to a current operating frequency of the GPU in a threshold table, respectively.

In exemplary embodiments in accordance with principles of inventive concepts, (b) includes comparing a number of frames processed by the GPU within a time period with a number of pulses of a display synchronization signal received within the time period.

In exemplary embodiments in accordance with principles of inventive concepts, the number of the frames processed by the GPU is equal to the number of the pulses of the display synchronization signal received within the time period while the GPU is in an idle state.

In exemplary embodiments in accordance with principles of inventive concepts, (a) to (c) are repeatedly performed for every time period.

In exemplary embodiments in accordance with principles of inventive concepts, a system-on-chip (SoC) includes: a graphics processing unit (GPU) configured to process image data and output the image data to a display device; and a dynamic voltage and frequency scaling (DVFS) controller configured to dynamically adjust the operating frequency of the GPU, based on the result of comparing the frame process speed of the GPU with the frame rate of the display device and the workload of the GPU.

In exemplary embodiments in accordance with principles of inventive concepts, the SoC is configured to compare the number of frames processed by the GPU within a time period to the number of pulses of a display synchronization signal received within the time period to produce the result of comparing the frame process speed of the GPU with the frame rate of the display device.

In exemplary embodiments in accordance with principles of inventive concepts, the SoC is configured to determine the workload of the GPU by dividing the sum of time periods that the GPU is activated within the time period by the time period.

In exemplary embodiments in accordance with principles of inventive concepts, the DVFS controller is configured to maintain the operating frequency of the GPU when the workload of the GPU is greater than an up-threshold and the number of frames processed by the GPU within the time period is equal to or greater than the number of the pulses of the display synchronization signal received within the time period.

In exemplary embodiments in accordance with principles of inventive concepts, the DVFS controller is configured to increase the operating frequency of the GPU when the workload of the GPU is greater than an up-threshold and the number of frames processed by the GPU within the time period is less than the number of pulses of the display synchronization signal received within the time period.

In exemplary embodiments in accordance with principles of inventive concepts, the DVFS controller is configured to reduce the operating frequency of the GPU when the workload of the GPU is less than or equal to the up-threshold and is less than a down-threshold.

In exemplary embodiments in accordance with principles of inventive concepts, the DVFS controller is configured to set the up-threshold and the down-threshold to values corresponding to a current operating frequency of the GPU in a threshold table, respectively.

In exemplary embodiments in accordance with principles of inventive concepts, a system includes: a graphics processing unit (GPU) configured to process image data and output the image data to a display device; and a dynamic voltage and frequency scaling (DVFS) controller configured to dynamically adjust the operating frequency of the GPU, based on whether the frame process speed of the GPU is sufficient for the frame rate of the display device and the percentage of time the GPU is active.

In exemplary embodiments in accordance with principles of inventive concepts, a SoC includes the GPU and DVFS.

In exemplary embodiments in accordance with principles of inventive concepts, the active state of the GPU is indicated by an interrupt signal.

In exemplary embodiments in accordance with principles of inventive concepts, the system is a portable electronic device.

In exemplary embodiments in accordance with principles of inventive concepts, the system is a cellular telephone.

[symbol] .

### BRIEF DESCRIPTION OF THE DRAWINGS

Exemplary embodiments in accordance with principles of inventive concepts will be more clearly understood from the following detailed description taken in conjunction with the accompanying drawings in which:

FIG. 1 is a schematic block diagram of an electronic system according to exemplary embodiments in accordance with principles of inventive concepts;

FIG. 2 is a conceptual diagram illustrating the relationship between a dynamic voltage and frequency scaling (DVFS) controller and other devices in exemplary embodiments in accordance with principles of inventive concepts;

FIG. 3 is a detailed block diagram of the DVFS controller of FIG. 2;

FIG. 4 is a detailed block diagram of a system-on-chip (SoC) of FIG. 1;

FIG. 5 is a flowchart illustrating a method of operating a SoC according to exemplary embodiments in accordance with principles of inventive concepts;

FIG. 6 is a detailed flowchart illustrating the method of operating the SoC of FIG. 5;

FIG. 7 is a timing diagram illustrating an operating frequency of a graphics processing unit (GPU) according to exemplary embodiments in accordance with principles of inventive concepts; and

FIG. 8 is a block diagram of an electronic system including the SoC according to exemplary embodiments in accordance with principles of inventive concepts.

### DETAILED DESCRIPTION

Various exemplary embodiments will be described more fully hereinafter with reference to the accompanying drawings, in which exemplary embodiments are shown. Exemplary embodiments may, however, be embodied in many different forms and should not be construed as limited to exemplary embodiments set forth herein. Rather, these exemplary embodiments are provided so that this disclosure will be thorough, and will convey the scope of exemplary embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. The term “or” is used in an inclusive sense unless otherwise indicated.

It will be understood that, although the terms first, second, third, for example. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments in accordance with principles of inventive concepts will be explained in detail with reference to the accompanying drawings.

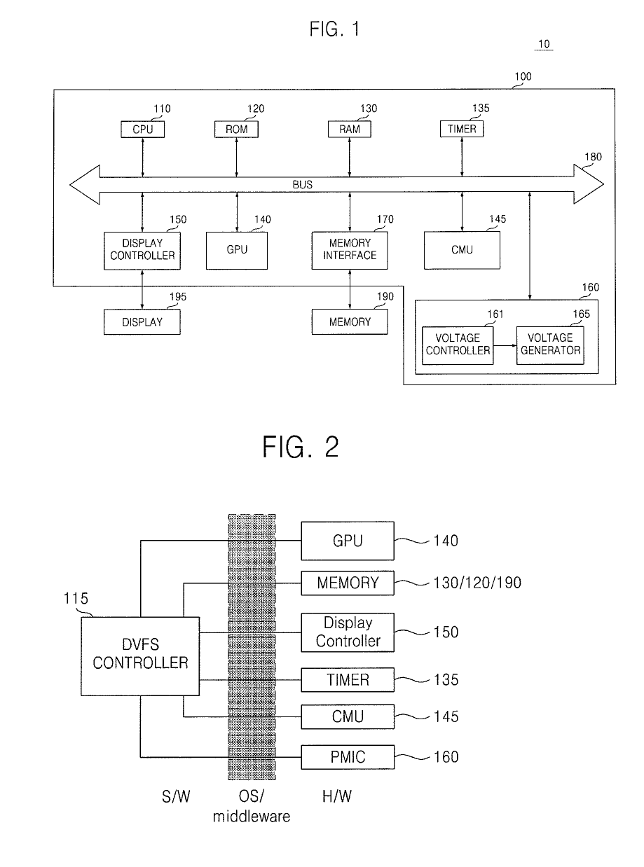

FIG. 1 is a schematic block diagram of an exemplary embodiment of an electronic system 10 in accordance with principles of inventive concepts. FIG. 2 is a conceptual diagram illustrating a relationship between an exemplary embodiment of a dynamic voltage frequency scaling (DVFS) controller 115 and other devices in accordance with principles of inventive concepts. Referring to FIG. 1, the electronic system 10 may be embodied as a handheld device, such as a mobile phone, a smart phone, a tablet computer, a personal digital assistant (PDA), an enterprise digital assistant (EDA), a digital still camera, a digital video camera, a portable multimedia player (PMP), a personal navigation device or portable navigation device (PND), a handheld game console, or an e-book reader, for example.

In an exemplary embodiment in accordance with principles of inventive concepts, electronic system 10 includes a system-on-chip (SoC) 100, a memory device 190, and a display device 195. The SoC 100 may include a central processing unit (CPU) 110, a read only memory (ROM) 120, a random access memory (RAM) 130, a timer 135, a graphics processing unit (GPU) 140, a clock management unit (CMU) 145, a display controller 150, a memory interface 170, and a bus 180. Although not shown, the SoC 100 may include other devices and the electronic system 10 may include a power management integrated circuit (PMIC) 160, for example.

In the exemplary embodiment of FIG. 1, the PMIC 160 is installed inside the SoC 100 but may be installed inside the SoC 100 according to another exemplary embodiment in accordance with principles of inventive concepts. The PMIC 160 may include a voltage controller 161 and a voltage generator 165.

The CPU 110 (also referred to as a processor) may process or execute programs and/or data stored in the memory device 190. For example, the CPU 110 may process or execute the programs and/or the data according to a clock signal output from a clock signal generator (not shown).

The CPU 110 may be embodied as a multi-core processor in accordance with principles of inventive concepts. The multi-core processor is one computing component including at least two independent and actual processors (referred to as cores). Each of the at least two processors is capable of reading and performing program instructions. Because a multi-core processor is capable of simultaneously driving a plurality of accelerators, a data processing system including the multi-core processor may perform multi-acceleration.

Programs and/or data stored in the ROM 120, the RAM 130, and the memory device 190 may be loaded to a memory of the CPU 110 if needed. The ROM 120 may store permanent programs and/or data and may be embodied as an erasable programmable read-only memory (EPROM) or an electrically erasable programmable read-only memory (EEPROM), for example.

The RAM 130 may temporarily store programs, data, or instructions. For example, programs and/or data stored in the ROM 120 or the memory device 190 may be temporarily stored in the RAM 130 under control of the CPU 110 or according to booting code stored in the ROM 120. The RAM 130 may be embodied as a dynamic RAM (DRAM) or a static RAM (SRAM), for example.

The GPU 140 may process data read from the memory device 190 by the memory interface 170 into a signal to be displayed.

In accordance with principles of inventive concepts, a performance monitoring unit (not shown) may be installed inside or at a front end of the GPU 140. Alternatively, the performance monitoring unit may be installed outside the GPU 140. The performance monitoring unit is a module configured to measure the workload of the GPU 140. For example, the performance monitoring unit may measure an amount of data input to the GPU 140 and/or an amount of data output from the GPU 140, and measure a memory usage of the GPU 140.

The CMU 145 may generate an operating clock signal and control an output of the operating clock signal. The CMU 145 may be embodied as a clock generation device such as a phase locked loop (PLL), a delayed locked loop (DLL), and a crystal, for example. The CMU 145 may supply the operating clock signal to the various elements: 110, 120, 130, . . . , 170.

The CMU 145 may change a frequency of the operating clock signal (hereinafter referred to as an ‘operating frequency’) under control of the DVFS control unit 115 of FIG. 2. For example, the DVFS controller 115 may select one of a plurality of policies that are preset based on the workloads of various modules such as the GPU 140, the CPU 110, etc. The plurality of policies (for example, a first DVFS policy and a second DVFS policy) may define preset operating frequencies and voltages, respectively.

The DVFS controller 115 may control the CMU 145 according to the selected policy. The CMU 145 may change the frequency of the operating clock signal under control of the DVFS controller 115.

The voltage controller 161 may control the voltage generator 165 based on the DVFS policy (first or second, for example) selected by the DVFS controller 115. The voltage generator 165 may generate one or more operating voltages for the various devices, for example, an operating voltage of the GPU 140, and apply the operating voltage to the GPU 140, under control of the voltage controller 161.

The memory interface 170 is a block configured to interface with the memory device 190. The memory interface 170 controls overall operations of the memory device 190, and controls exchange of various data between a host (not shown) and the memory device 190. For example, the memory interface 170 may control data to be written to or read from the memory device 190, in response to a request from the host.

The host may be a processing unit such as the CPU 110, the GPU 140, or the display controller 150, for example.

The memory device 190 may be a space for storing data, and may store an operating system (OS), various programs, and various data and may be a DRAM but is not limited thereto. For example, the memory device 190 may be a nonvolatile memory device, for example, a flash memory, a phase-change RAM (PRAM), a magneto-resistive RAM (MRAM), a resistive RAM (ReRAM), or a ferroelectric RAM (FeRAM). In an exemplary embodiment in accordance with principles of inventive concepts, the memory device 190 may be a built-in memory installed in the SoC 100.

The devices 110 to 150 and 170 may communicate with one another via the bus 180.

The display device 195 may generate a display synchronization signal, and display an output image signal of the display controller 150 based on, or under control of, the display synchronization signal. The display synchronization signal may be a vertical synchronization signal VSYNC. The display device 195 may be embodied as a liquid crystal display (LCD), a light-emitting diode (LED), an organic LED (OLED), or an active-matrix OLED (AMOLED) device.

The display controller 150 controls operations of the display device 195.

The DVFS controller 115 may be implemented as hardware for performing functions and operations of various devices described in the present disclosure, computer program code for performing a specific function and operation, or an electronic recording medium having recorded thereon the computer program code for performing a specific function and operation, for example, a processor. That is, the DVFS controller 115 may be implemented as a functional and structural combination of hardware for performing operations in accordance with principles of inventive concepts and/or software for driving the hardware.

In exemplary embodiments in accordance with principles of inventive concepts, the DVFS controller 115 may be operated by a module capable of performing direct memory access (DMA), for example, the CPU 110.

The memories 130, 120, and 190, the timer 135, the GPU 140, the CMU 145, the PMIC 160, and other modules may be controlled by operating the DVFS controller 115 under control of the CPU 110. The memories 130, 120, and 190, the timer 135, the GPU 140, the CMU 145, and the PMIC 160 may be hardware (H/W) components.

An operating system (OS) and middleware may be interposed between the DVFS controller 115 and the memories 120, 130, and 190, the timer 135, the GPU 140, the CMU 145, and the PMIC 160, for example.

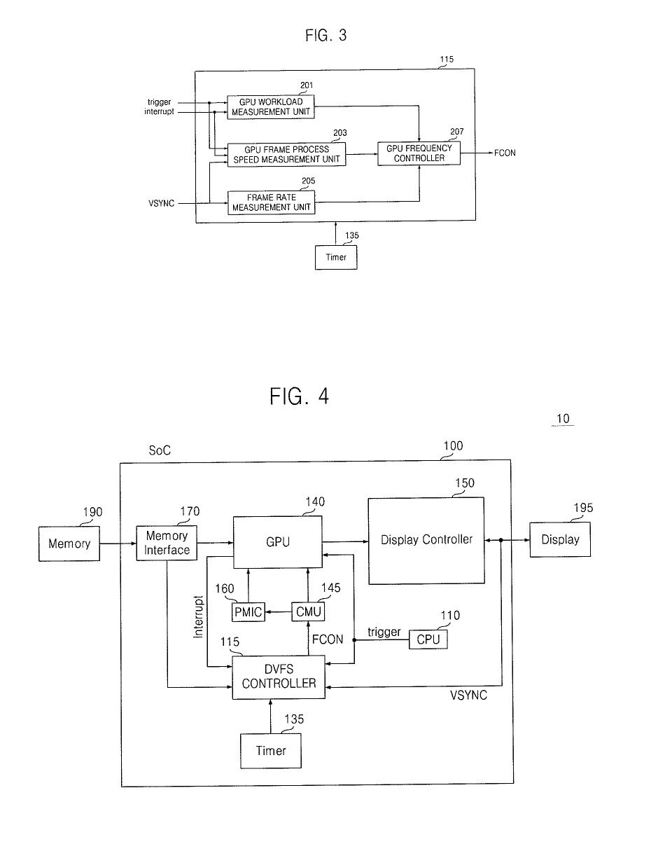

FIG. 3 is a more detailed block diagram of an exemplary embodiment of a DVFS controller in accordance with principles of inventive concepts, such as the DVFS controller 115 of FIG. 2.

Referring to FIG. 3, the DVFS controller 115 may include a GPU workload measurement unit 201, a GPU frame process speed measurement unit 203, a frame rate measurement unit 205, and a GPU frequency controller 207.

In operation, DVFS controller 115 receives signals related to an operating state of the GPU 140 from the CPU 110 and the GPU 140, and receives a display synchronization signal generated by the display device 195. For example, the DVFS controller 115 may receive a trigger signal from the CPU 110, an interrupt signal from the GPU 140, and a vertical synchronization signal VSYNC from the display device 195.

In exemplary embodiments in accordance with principles of inventive concepts, the trigger signal may be transmitted from the CPU 110 to the GPU 140 when the CPU 110 assigns a task to the GPU 140. The interrupt signal is transmitted from the GPU 140 to the CPU 110 to indicate that the task is completed, after the GPU 140 completes the work. That is, the trigger signal indicates a point of time when the GPU 140 is switched from an idle state to an active state, and the interrupt signal indicates a point of time when the GPU 140 is switched from the active state (also referred to herein as “activated”) to the idle state. Thus, the DVFS controller 115 may determine the operating state of the GPU 140, based on the trigger signal and the interrupt signal, for example.

The GPU workload measurement unit 201 measures the workload of the GPU 140, based on the trigger signal and the interrupt signal. The workload of the GPU 140 may be determined by dividing the sum of time periods that the GPU 140 is activated within a time period, which may be a predetermined time period by the length of the time period. The time period may be measured using the timer 135.

The GPU frame process speed measurement unit 203 may measure a frame process speed of the GPU 140. In exemplary embodiments in accordance with principles of inventive concepts, the frame process speed of the GPU 140 is equal to the number of frames processed by the GPU 140 within the time period used to determine the workload of the GPU 140.

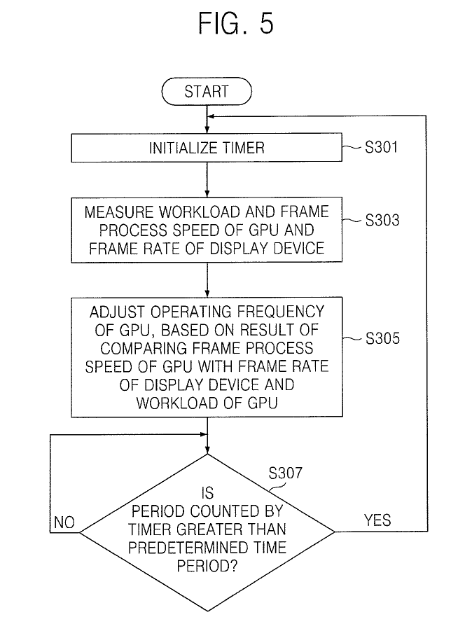

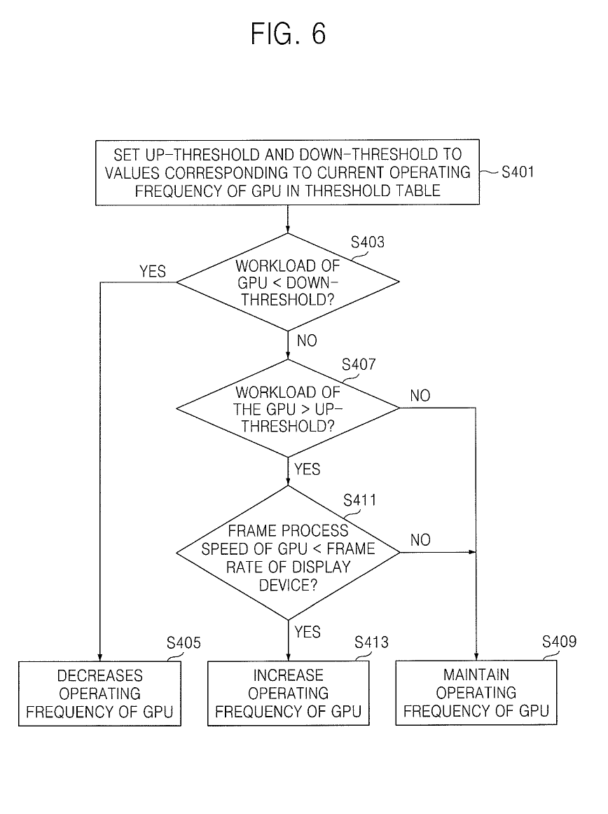

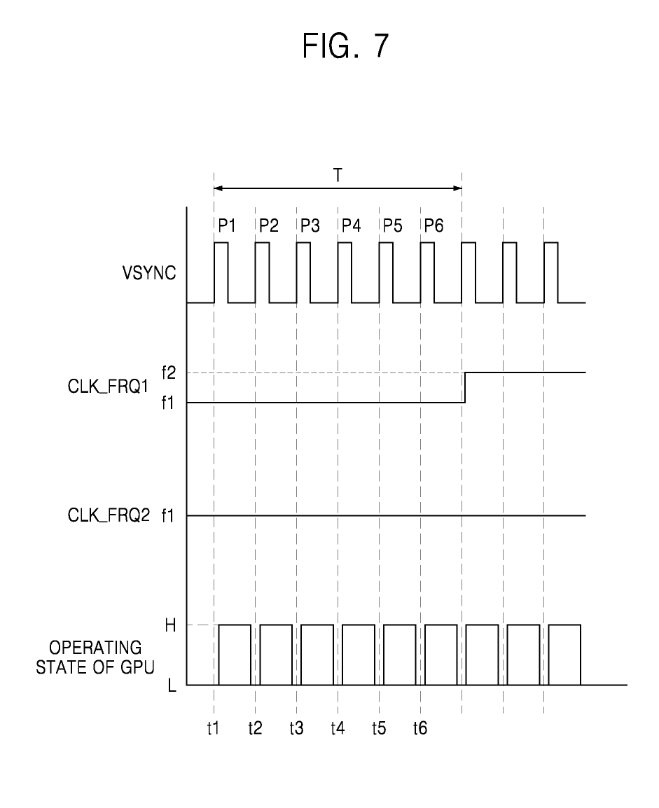

The frame rate measurement unit 205 may measure a frame rate of the display device 195. The frame rate is the number of frames to be displayed on the display device 195 per second. For convenience of explanation, operations of the GPU frame process speed measurement unit 203 and the frame rate measurement unit 205 will be described with reference to FIG. 7 below. The GPU frequency controller 207 generates and outputs a GPU frequency control signal FCON, based on the workload and frame process speed of the GPU 140 and the frame rate of the display device 195. For convenience of explanation, operation of the GPU frequency controller 207 will be described with reference to FIGS. 5 and 6 below.

FIG. 4 is a detailed block diagram of an exemplary embodiment of a SoC in accordance with principles of inventive concepts, such as SoC 100 of FIG. 1.

Referring to FIG. 4, the GPU 140 receives data read from the memory device 190 by the memory interface 170, processes the data into a signal to be displayed, and outputs the signal to the display device 195 via the display controller 150.

The DVFS controller 115 may receive a trigger signal from the CPU 110, an interrupt signal from the GPU 140, and a vertical synchronization signal VSYNC from the display device 195, for a predetermined time period measured by the timer 135.

The DVFS controller 115 may receive a threshold table from the memory device 190. The threshold table may store an up-threshold and a down-threshold corresponding to each of a plurality of operating frequencies of the GPU 140. The up-threshold and down-threshold may be used in combination with other factors to be described below to respectively increase or decrease the operating frequency of the GPU 140. In other exemplary embodiments in accordance with principles of inventive concepts, the DVFS controller 115 may receive the threshold table from the ROM 120 or the RAM 130, for example.

The DVFS controller 115 may generate a GPU frequency control signal FCON based on the received signals, and output the GPU frequency control signal FCON to the CMU 145. The CMU 145 may adjust the operating frequency of the GPU 140 based on the GPU frequency control signal FCON, and control the PMIC 160 to adjust the operating voltage of the GPU 140. In other exemplary embodiments in accordance with principles of inventive concepts, the DVFS controller 115 may directly control the PMIC 160 to adjust the operating voltage of the GPU 140.

In exemplary embodiments in accordance with principles of inventive concepts, DVFS controller 115 of FIG. 4 is a module that is installed separately from other modules. However, in other exemplary embodiments in accordance with principles of inventive concepts, the DVFS controller 115 may be embodied at least partially as instructions run by a module capable of performing direct memory access (DMA), for example, the CPU 110.

FIG. 5 is a flowchart illustrating an exemplary embodiment of a method in accordance with principles of inventive concepts of operating a SoC.

Referring to FIGS. 4 and 5, the DVFS controller 115 initializes the timer 135 (operation S301).

The DVFS controller 115 may receive an interrupt signal from the GPU 140 and a vertical synchronization signal VSYNC from the display device 195, for a predetermined time period. Then, the DVFS controller 115 measures the workload and frame process speed of the GPU 140 and a frame rate of the display device 195, based on the received signals (operation S303).

Then, the DVFS controller 115 controls the CMU 145 to adjust an operating frequency of the GPU 140, based on a result of comparing the frame process speed of the GPU 140 with the frame rate of the display device 190 and the workload of the GPU 140 (operation S305).

Then, the DVFS controller 115 determines whether a time period counted by the timer 135 is greater than the predetermined time period (operation S307). When the counted time period is greater than the predetermined time period, the DVFS controller 115 performs operations S301 to S305 again.

FIG. 6 is a detailed flowchart illustrating an exemplary embodiment of a method of operating a SoC in accordance with principles of inventive concepts, such as SoC 100 of FIG. 5. The adjusting of the operating frequency of the GPU 140 (operation S305) included in the method of FIG. 5 may be performed as illustrated in FIG. 6, for example.

Referring to FIGS. 2 and 6, the ROM 120, the RAM 130, or the memory device 190 may store a threshold table, for example. The threshold table may store an up-threshold and a down-threshold corresponding to each of a plurality of operating frequencies of the GPU 140. The DVFS controller 115 may receive the threshold table from one of the ROM 120, the RAM 130, and the memory device 190. The DVFS controller 115 may set an up-threshold and a down-threshold to values corresponding to a current operating frequency of the GPU 140 in the threshold table (operation S401). The up-threshold may be a threshold value of the GPU 140 workload that may be used to determine when to increase the frequency of operation of the GPU 140 and the down-threshold may be a threshold value of the GPU 140 workload that may be used to determine when to decrease the frequency of operation of the GPU 140, for example. In this exemplary embodiment in accordance with principles of inventive concepts, the up-threshold is greater than the down-threshold.

Then, the DVFS controller 115 compares the workload of the GPU 140 with the down-threshold (operation S403).

If the workload of the GPU 140 is less than the down-threshold, the DVFS controller 115 decreases the operating frequency of the GPU 140 (operation S405).

If the workload of the GPU 140 is equal to or greater than the down-threshold, the DVFS controller 115 compares the workload of the GPU 140 with the up-threshold (operation S407). If the workload of the GPU 140 is less than or equal to the up-threshold, the DVFS controller 115 maintains the operating frequency of the GPU 140 (operation S409).

If the workload of the GPU 140 is greater than the up-threshold, the DVFS controller 115 compares a frame process speed of the GPU 140 with a frame rate of the display device 195 (operation S411).

If the frame process speed of the GPU 140 is equal to or greater than the frame rate of the display device 195, the DVFS controller 115 maintains the operating frequency of the GPU 140 (operation S409).

If the frame process speed of the GPU 140 is less than the frame rate of the display device 195, the DVFS controller 115 increases the operating frequency of the GPU 140 (operation S413).

In the exemplary embodiment of a method of operating a SoC in accordance with principles of inventive concepts illustrated in FIG. 6, first, the workload of the GPU 140 is compared with the down-threshold and the up-threshold, and the frame process speed of the GPU 140 is then compared with the frame rate of the display device 195. However, the order of the comparisons may be reversed and inventive concepts are not limited by the embodiment of the FIG. 6. That is, for example, operation S407 and operation S411 may be switched to each other, and operation S403 may be performed after operation S409.

FIG. 7 is a timing diagram illustrating an operating frequency of a GPU according to an embodiment of the inventive concept.

In FIG. 7, ‘T’ denotes a predetermined time period counted by the timer 135 of FIG. 1. For convenience of explanation and illustrative purposes, it is assumed that the present time period T is 100 ms. However, in accordance with principles of inventive concepts, the predetermined time period T may be set to a different value.

‘VSYNC’ is a vertical synchronization signal that is output from the display device 195 of FIG. 1 and that may include a plurality of pulses P1, P2, . . . , P6 (hereinafter referred to as ‘display synchronization signal pulses’ or ‘VSYNC pulses’) within the predetermined time period T.

In exemplary embodiments in accordance with principles of inventive concepts, an operating state signal of the GPU 140 of FIG. 1 indicates whether the GPU 140 currently operates or not, and may be an activate state or an idle state. In exemplary embodiments, GPU 140 is in the activate state when the operating state of the GPU 140 is a logic high (H) level, and is in the idle state when the operating state of the GPU 140 is a logic low (L) level.

In exemplary embodiments in accordance with principles of inventive concepts, the workload of the GPU 140 may be determined by dividing the sum of time periods that the GPU 140 is in the activate state for the predetermined time period T by the predetermined time period T. In the current illustrative example , it is assumed that the workload of the GPU 140 is greater than an up-threshold.

‘CLK_FRQ1’ is the operating frequency of the GPU 140 in an example offered for comparison in which the frame rate of the display device 195 of FIG. 1 is not considered. ‘CLK_FRQ2’ is the operating frequency of the GPU 140 according to an embodiment of the inventive concept in which the operating frequency of the GPU 140 has an initial value ‘f1’.

In the example offered for comparison, in which the frame rate of the display device 195 is not considered, the DVFS controller 115 measures only the workload of the GPU 140 for the time period T. Because the measured workload is greater than the up-threshold, the DVFS controller 115 increases the operating frequency CLK_FRQ1 of the GPU 140 to a value ‘f2’ that is greater than the initial value ‘f1’.

In an exemplary embodiment in accordance with principles of inventive concepts, for the time period T, the DVFS controller 115 not only measures the workload of the GPU 140 but also measures and compares the frame process speed of the GPU 140 and the frame rate of the display device 195.

In exemplary embodiments in accordance with principles of inventive concepts, the frame rate of the display device 195 may be calculated based on the number of VSYNC pulses received by the DVFS controller 115 for the predetermined time period T, for example.

In exemplary embodiments in accordance with principles of inventive concepts, the frame process speed of the GPU 140 may be calculated based on the number of frames processed by the GPU 140 for the predetermined time period T, for example. The number of frames processed by the GPU 140 may be equal to the number of VSYNC pulses received by the DVFS controller 115 during the idle state of the GPU 140. In an exemplary embodiment in accordance with principles of inventive concepts, because the DVFS controller 115 receives six VSYNC pulses P1, P2, . . . , P6 for the predetermined time period T (T=100 ms), the frame rate of the display device 195 is 60 frames per second (fps).

When the DVFS controller 115 receives the six VSYNC pulses Pl, P2, . . . , P6 at points of time t1, t2, . . . , t6, the operating state of the GPU 140 is always in a logic low (L) level. Thus, while the GPU 140 is in the idle state, the number of VSYNC pulses received by the DVFS controller 115 is six and the frame process speed of the GPU 140 is 60 fps.

Because the frame process speed of the GPU 140 and the frame rate of the display device 195 are the same, the DVFS controller 115 maintains the operating frequency CLK_FRQ2of the GPU 140 at the same value f1.

If the frame process speed of the GPU 140 is equal to or greater than the frame rate of the display device 195, the display device 195 outputs the same image even when the operating frequency CLK_FRQ2 of the GPU 140 increases. In this manner, the DVFS controller 115 prevents unnecessary power consumption by maintaining the operating frequency CLK_FRQ2 of the GPU 140 at the same value f1. That is, in accordance with principles of inventive concepts, both the workload of the GPU and the relationship between the frame process speed of the GPU and the frame rate of the display device are examined and the operating frequency of the GPU is only increased if the workload of the GPU is greater than the up-threshold and the frame process speed of the GUP is less than the frame rate of the display device. As a result, the frequency of the GPU is not unnecessarily increased, and power is saved, during times when the workload of the GPU is greater than the up-threshold but the frame process speed is greater than or equal to the frame rate of the display device.

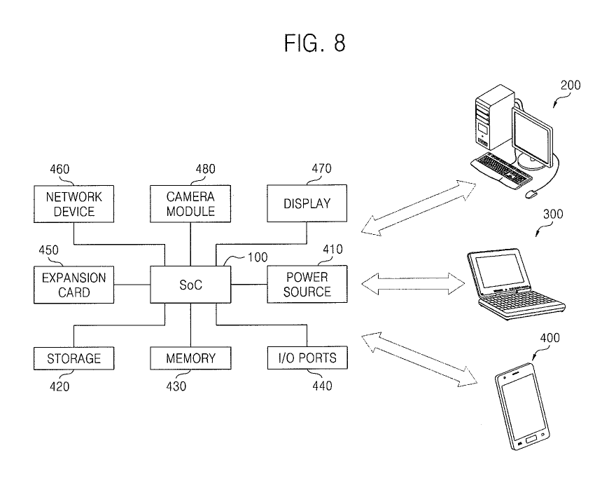

FIG. 8 is a block diagram of an exemplary embodiment of an electronic system in accordance with principles of inventive concepts that includes SoC 100 in accordance with principles of inventive concepts. Referring to FIG. 8, the electronic system may be implemented as a personal computer (PC) or a data server 200, a laptop computer 300, or a portable device 400, for example. The portable device 400 may be a cellular phone, a smart phone, a tablet personal computer (PC), a personal digital assistant (PDA), an enterprise digital assistant (EDA), a digital still camera, a digital video camera, a portable multimedia player (PMP), portable navigation device(PDN), a handheld game console, or an e(electronic)-book device, for example.

In exemplary embodiments in accordance with principles of inventive concepts, electronic system 200, 300 or 400 includes the SoC 100, a power source 410, a storage device 420, a memory 430, I/O ports 440, an expansion card 450, a network device 460, and a display 470. The electronic system 200, 300 or 400 may further include a camera module 480, for example.

The SoC 100 corresponds to the SoC 100 illustrated in FIG. 1 and may control the operation of at least one of the elements 410 through 480. The power source 410 may supply an operating voltage to at least one of the elements 100, and 420 through 480. The storage device 420 may be implemented by a hard disk drive (HDD) or a solid state drive (SSD), for example.

The memory 430 may be implemented using a volatile or non-volatile memory and may correspond to the memory device 190 illustrated in FIG. 1. A memory controller (not shown) that controls a data access operation, for example, a read operation, a write operation (or a program operation), or an erase operation, on the memory 430 may be integrated into or embedded in the SoC 100. Alternatively, the memory controller may be provided between the SoC 100 and the memory 430.

The I/O ports 440 are ports that receive data transmitted to the electronic system 200, 300 or 400 or transmit data from the electronic system 200, 300 or 400 to an external device. For example, the I/O ports 440 may include a port connecting with a pointing device such as a computer mouse, a port connecting with a printer, and a port connecting with a USB drive.

The expansion card 450 may be implemented as a secure digital (SD) card or a multimedia card (MMC) and may be a subscriber identity module (SIM) card or a universal SIM (USIM) card.

In exemplary embodiments in accordance with principles of inventive concepts, network device 460 enables the electronic system 200, 300 or 400 to be connected with a wired or wireless network. The display 470 may display data output from the storage device 420, the memory 430, the I/O ports 440, the expansion card 450, or the network device 460.

The camera module 480 may convert optical images into electrical images. Accordingly, the electrical images output from the camera module 480 may be stored in the storage module 420, the memory 430, or the expansion card 450. The electrical images output from the camera module 480 may also be displayed through display 470.

Methods in accordance with principles of inventive concepts may be embodied as computer-readable codes on a computer-readable medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices.

The computer-readable recording medium can also be distributed over network coupled computer systems so that the computer-readable code is stored and executed in a distributed fashion. Also, functional programs, codes, and code segments to accomplish the present general inventive concept can be easily construed by programmers.

In a SoC and a method of operating the same in accordance with principles of inventive concepts, an operating frequency of a GPU is dynamically controlled in consideration of both a workload of the GPU and a frame rate of a display device, thereby reducing power consumption.

While the inventive concept has been particularly shown and described with reference to exemplary embodiments thereof, it will be understood that various changes in form and details may be made therein without departing from the spirit and scope of inventive concepts, as set forth in the following claims.

What is claimed is:

1. A method comprising:
(a) measuring a workload and frame process speed of a graphics processing unit (GPU) and a frame rate of a display device;
(b) comparing the frame process speed of the GPU with the frame rate of the display device; and
(c) adjusting an operating frequency of the GPU, based on a comparison result and the workload of the GPU.

2. The method of claim 1, wherein (c) comprises maintaining the operating frequency of the GPU when the workload of the GPU is greater than an up-threshold and the frame process speed of the GPU is equal to or greater than the frame rate of the display device.

3. The method of claim 1, wherein (c) comprises increasing the operating frequency of the GPU when the workload of the GPU is greater than an up-threshold and the frame process speed of the GPU is less than the frame rate of the display device.

4. The method of claim 2, wherein (c) further comprises reducing the operating frequency of the GPU when the workload of the GPU is less than or equal to the up-threshold and is less than a down-threshold.

5. The method of claim 4, wherein the up-threshold and the down-threshold are values corresponding to a current operating frequency of the GPU in a threshold table, respectively.

6. The method of claim 1, wherein (b) includes comparing a number of frames processed by the GPU within a time period with a number of pulses of a display synchronization signal received within the time period.

7. The method of claim 6, wherein the number of the frames processed by the GPU is equal to the number of the pulses of the display synchronization signal received within the time period while the GPU is in an idle state.

8. The method of claim 6, wherein (a) to (c) are repeatedly performed for every time period.

9. A system-on-chip (SoC) comprising:
a graphics processing unit (GPU) configured to process image data and output the image data to a display device; and
a dynamic voltage and frequency scaling (DVFS) controller configured to dynamically adjust an operating frequency of the GPU, based on a result of comparing a frame process speed of the GPU with a frame rate of the display device and a workload of the GPU.

10. The SoC of claim 9, wherein the SoC is configured to compare the number of frames processed by the GPU within a time period to the number of pulses of a display synchronization signal received within the time period to produce the result of comparing the frame process speed of the GPU with the frame rate of the display device.

11. The SoC of claim 10, wherein the SoC is configure to determine the workload of the GPU by dividing the sum of time periods that the GPU is activated within the time period by the time period.

12. The SoC of claim 10, wherein the DVFS controller is configured to maintain the operating frequency of the GPU when the workload of the GPU is greater than an up-threshold and the number of frames processed by the GPU within the time period is equal to or greater than the number of the pulses of the display synchronization signal received within the time period.

13. The SoC of claim 10, wherein the DVFS controller is configured to increase the operating frequency of the GPU when the workload of the GPU is greater than an up-threshold and the number of frames processed by the GPU within the time period is less than the number of pulses of the display synchronization signal received within the time period.

14. The SoC of claim 12, wherein the DVFS controller is configured to reduce the operating frequency of the GPU when the workload of the GPU is less than or equal to the up-threshold and is less than a down-threshold.

15. The SoC of claim 14, wherein the DVFS controller is configured to set the up-threshold and the down-threshold to values corresponding to a current operating frequency of the GPU in a threshold table, respectively.

16. A system, comprising:
a graphics processing unit (GPU) configured to process image data and output the image data to a display device; and
a dynamic voltage and frequency scaling (DVFS) controller configured to dynamically adjust the operating frequency of the GPU, based on whether the frame process speed of the GPU is sufficient for the frame rate of the display device and the percentage of time the GPU is active.

17. The system of claim 16, wherein the system comprises a SoC including the GPU and the DVFS controller.

18. The system of claim 17, wherein an active state of the GPU is indicated by an interrupt signal.

19. The system of claim 17, wherein the system is a portable electronic device.

20. The system of claim 19, wherein the system is a cellular telephone.
